(19) United States
(12) Patent Application Publication
(10) Pub. No.: US 2022/0072667 A1
(43) Pub. Date: Mar. 10, 2022

(54) An electrospindle

(71) Applicant: Saccardo Elettromeccanica S.r.l., Santorso (VI) (IT)

(72) Inventor: Francesca Saccardo, Santorso (VI) (IT)

(21) Appl. No.: 17/423,830

(22) PCT Filed: Apr. 29, 2019
(86) PCT No.: PCT/IB2019/053481

§ 371 Date: Jul. 16, 2021

(30) Foreign Application Priority Data
Jan. 23, 2019 (IT) 102019000001029

(51) Int. Cl. B23Q 3/12; B24B 23/02; B24B 45/00; B26D 7/26

(52) U.S. Cl. CPC B23Q 3/12; B24B 23/022; B27B 5/32; B26D 7/2621; B24B 45/006

(57) ABSTRACT

An electrospindle includes a motor for moving a tool and a motor shaft for transmitting motion from the motor to the tool. The electrospindle has a gripping head of the tool and a coupling of the tool to the motor shaft, and the gripping head includes two flanges, between which a portion of the tool and at least one thrust nut of a first flange can be interposed toward a counterflange, so as to hold the tool in position. The transmission has a free end threaded so as to receive the at least one thrust nut by screwing, the thread of the free end being double with a first right-handed thread and a second left-handed thread.

### FIELD OF APPLICATION

The present invention is applicable to the field of industrial machining operations and, in particular, concerns machine tools.

More in detail, the present invention relates to an electrospindle for industrial machining operations.

### BACKGROUND ART

It is known that material machining operations in the industrial field now take place almost exclusively by electric tools. Operations such as cutting, bending, milling, drilling or other, in fact, typically take place by means of special machines equipped with the appropriate tools to perform the machining.

Among these machines, there are numerous cases in which they comprise electrospindles, i.e. mechanical devices, installed on the machine tool, on which a self-centering device can be mounted which allows a tool to be dragged in rotation in order to be able to perform a certain type of machining with it.

This tool is typically held in position by the head of the electrospindle. The latter is associated with the free end of the motor shaft and comprises two flanges which hold the tool necessary for machining between them. More in detail, a first flange is pushed against a counterflange, integral with the motor shaft, by a nut screwed to the free end of the motor shaft.

Moreover, in some variants, the free end of the motor shaft also has a threaded blind hole which extends along the longitudinal development axis of the shaft and which receives, by screwing, a second tool.

This configuration, although useful and functional, has some drawbacks.

It is in fact known that the motors have their own sense of rotation (right-handed or left-handed) which could also be reversed to speed up the machining operations. However, the threads of the nut and the free end of the motor shaft, as well as those of the blind hole and of the additional tool, must be in accordance with these rotation directions in order to avoid unwanted unscrewing. All this results in the presence of different motor shafts, that is, one for each rotation combination of the motor and tools. The user who wants to be able to use any of these combinations should therefore have different motor shafts and replace them with one another according to the machining need.

Moreover, in any case, the reversal of the motor rotation direction is not allowed except by replacing the shaft.

### PRESENTATION OF THE INVENTION

The object of the present invention is to overcome at least partially the drawbacks described above by providing an electrospindle in which it is not necessary to replace the motor shaft to be able to invert the rotation direction of the motor itself.

In particular, an object of the present invention is to provide an electrospindle in which the possible combinations between the rotation direction of the motor and the attachment of the tools does not require the use of different motor shafts.

These objects, as well as others which will be better understood below, are achieved by an electrospindle according to one or more of the following claims, which are an integral part of the present invention.

In particular, it comprises a motor for moving a tool and a mechanical transmission for transmitting motion from the motor to the tool.

The electrospindle is also provided with a gripping head for the tool and for coupling the latter with the mechanical transmission, this head in turn comprising two flanges between which a portion of the tool can be interposed. In particular, a first flange is pushed against a counterflange by at least one thrust nut so as to hold the tool in position.

According to an aspect of the invention, the transmission has a threaded free end so as to receive the thrust nut by screwing. The thread is double comprising a first right-handed thread and a second left-handed thread.

Advantageously, therefore, the reversal of the rotation direction of the motor does not require the changing of the motor shaft. It is in fact sufficient to use a nut with the opposite thread.

According to another aspect of the invention, moreover, the electrospindle comprises a first nut with a thread suitable for coupling with the first thread (the right-handed one) and a second nut with a thread suitable for coupling with the second thread (the left-handed one).

Advantageously, therefore, the reversal of the rotation direction of the motor does not even require the replacement of the thrust nut. In fact, for each rotation direction, one of the two nuts makes the seal.

Still advantageously, the rotation direction can be inverted at any instant even during machining, thereby allowing to speed up the work of the electric tool and consequently reduce the production or machining costs.

### BRIEF DESCRIPTION OF THE DRAWINGS

Further features and advantages of the invention will be more evident in light of the detailed description of some of the preferred but not exclusive embodiments of an electrospindle according to the invention, illustrated by way of non-limiting example with the aid of the accompanying drawing tables, wherein:

FIG. 1 represents a portion of an electrospindle according to the invention in a sectional view;

FIG. 2 represents a detail of an electrospindle according to the invention in a perspective view.

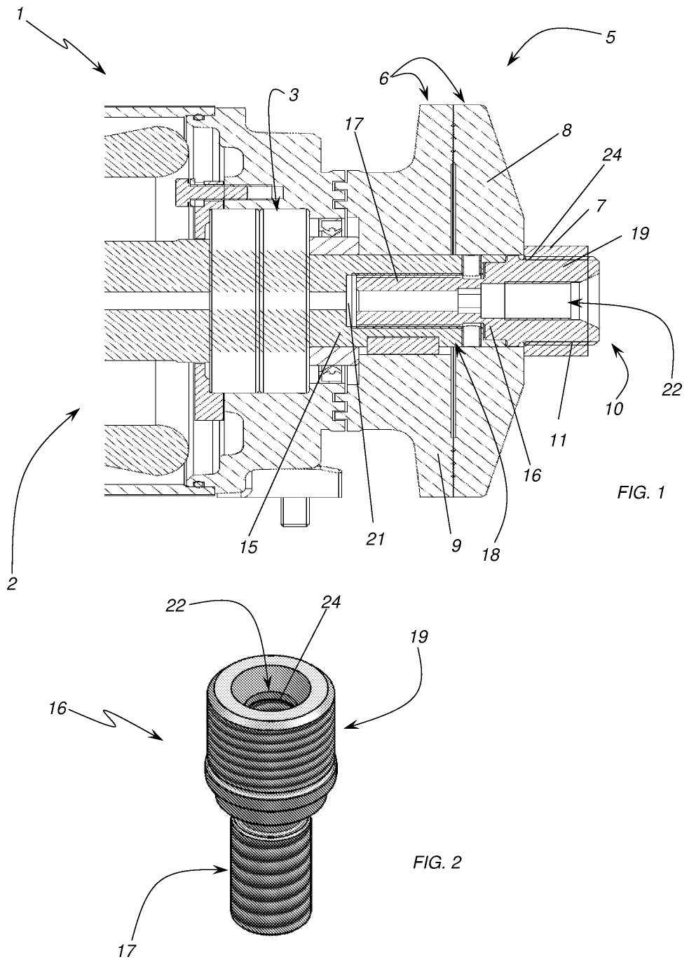

### DETAILED DESCRIPTION OF SOME PREFERRED EXEMPLARY EMBODIMENTS

With reference to the mentioned figures, described herein is an electrospindle 1 commonly used for machining operations such as cutting, milling, drilling or other.

By definition, an electrospindle 1 comprises a motor 2 for moving a tool, not represented in the figures, and a mechanical transmission 3 for transmitting motion from the motor 2 to the tool.

The power of the motor 2 is typically adequate for the use to which the electrospindle 1 is directed and, consequently, also the embodiment of the mechanical transmission 3 is consequent to the efforts that it must bear.

According to an aspect of the invention, the electrospindle 1 comprises a gripping head 5 of the tool. Moreover, this head 5 not only retains the tool, but realizes the coupling between the latter and the mechanical transmission 3.

In particular, the head 5 comprises two flanges 6 between which a portion of the tool can be interposed. There is also a thrust nut 7 which has the function of pushing a first flange 8 towards the counterflange 9 so as to hold the tool between them.

More in detail, the mechanical transmission 3 has a free end 10 threaded so as to receive the thrust nut 7 by screwing.

According to another aspect of the invention, the thread 11 of the free end10 of the transmission 3 is double comprising a first right-handed thread and a second left-handed thread.

Advantageously, therefore, on the same free end 10 both right-handed and left-handed thrust nuts 7 can be screwed. In other words, the mechanical transmission 3 can be used indifferently with right-handed or left-handed tools.

In other words, advantageously, changing the rotation direction of the motor 2 to perform a machining operation does not require the replacement of the mechanical transmission 3 or of a part thereof.

However, this still advantageously limits the number of components to be provided in the production of the electrospindle 1 of the invention.

In order to ensure the tightness of the thrust nut 7, according to an embodiment variant not shown in the figures, the electrospindle comprises two thrust nuts: a first nut with a thread suitable for coupling with the first thread, and a second nut with a thread suitable for coupling with the second thread.

In this way, advantageously, whatever the direction of rotation imposed by the motor, the tool is correctly held in position since at least one of the first and second nuts will not be urged to unscrew.

Still advantageously, the same tool can be used with both rotation directions, thus speeding up machining and reducing machine downtime.

According to one aspect of the embodiment variant which is described, the first nut and the second nut comprise mutual coupling means, but this detail must not be considered limiting for further different embodiment variants. These coupling means, however, allow a better management of the nuts since, being one connected to the other, it is impossible for them to accidentally unscrew by repeatedly reversing the rotation directions during machining.

According to another aspect of the invention, the mechanical transmission 3 comprises a motor shaft 15 having a first end, not shown in the figures, operatively coupled to the engine 2, and an insert 16 having a first side 17 coupled by screwing to the second end 18 of the motor shaft 15. Moreover, the second side 19 of the insert 16 constitutes the free end 10 of the transmission 3.

In this case, the counterflange 9 of the head 5 is integral with the motor shaft 15, while the thrust nut 7 is coupled to the insert 16.

Advantageously, therefore, the second end 18 of the motor shaft 15 is no longer protruding from the head 5, as instead occurs in the known art, but the insert 16 is protruding. Still advantageously, therefore, the motor shaft 16, whose operation is delicate and therefore expensive, is more protected from unwanted damage.

Since the thrust nut 7 is screwed onto the insert 16, in substance, still advantageously, the latter functionally replaces the motor shaft 15, cooperating in retaining the tool.

Still advantageously, in the event of damage or deterioration, the replacement of the insert 16 is easier and less expensive than the replacement of the motor shaft 15 not only in terms of time for performing such a replacement and of downtime, but also in terms of materials used to make such piece.

Still advantageously, in fact, the insert 16 can be made of the most suitable material for its exposed positioning. In particular, it can be made with a less expensive material than the motor shaft 15 and suitably hardened.

Its coupling by screwing to the motor shaft 15 also allows to obtain an advantageously stable but low-cost coupling.

More in detail, the first side 17 of the insert 16 is threaded, while the second end 18 of the motor shaft 15 comprises a first hole 21 typically but not necessarily blind which extends along the longitudinal development axis of the motor shaft 15 and which is counter-shaped on the first side 17 of the insert 16. Moreover, this first hole 21 is threaded to receive said first side 17 of the insert 16 by screwing.

However, this embodiment should not be considered as limiting for the invention. According to an embodiment variant, in fact, the transmission comprises only the motor shaft and not the insert, the second end of the motor shaft constituting the free end of the transmission.

According to another aspect of the invention, the second side 19 of the insert 16 also comprises a second hole 22 which is also typically but not necessarily blind, which extends along the longitudinal development axis of the insert 16 itself to receive and retain an additional tool.

This second hole 22 is typically threaded to retain the additional tool by screwing. In the industry jargon, the second tool connection which was just mentioned is referred to as “half throttle”.

According to a further aspect of the invention, also the thread 24 of the second hole 22 is double comprising a third right-handed thread and a fourth left-hand thread so as to be able to screw both right-handed and left-handed additional tools.

Advantageously, therefore, the double thread 24 of the second hole 22 makes it possible to reduce even more the reasons for replacing the insert 16 or, in the case of the above-described embodiment variant, of the entire motor shaft.

In light of the above, it is therefore understood that the electrospindle of the invention overcomes the drawbacks noted in the prior art.

In particular, it makes it possible to invert the rotation direction of the motor to perform a machining operation without it being necessary to replace the motor shaft.

On closer inspection, the different possible combinations between the rotation direction of the motor and fixing of the tools does not require the use of different motor shafts with the electrospindle of the invention.

Although the invention has been described with particular reference to the accompanying figures, the reference numerals used in the description and claims are used to improve the intelligence of the invention and do not constitute any limitation to the claimed scope of protection.

The invention claimed is:

1. An electrospindle comprising:
a motor for moving a tool; and
a mechanical transmission for transmitting a motion from said motor to the tool; and
a gripping head of the tool for coupling the tool to said mechanical transmission, said gripping head comprising at least two flanges adapted to grip a portion of the tool, a first flange of said at least two flanges being pushed against a counterflange of said at least two flanges by at least one thrust nut, so as to hold the tool in position,
wherein said mechanical transmission has a free end threaded so as to receive said at least one thrust nut by screwing, a thread of said free end of said mechanical transmission being double by comprising a first right-handed thread and a second left-handed thread.

2. The electrospindle according to claim 1, wherein said at least one thrust nut comprises a first nut with a thread configured for coupling with said first thread of said free end of said mechanical transmission and a second nut with a thread configured for coupling with said second thread of said free end of said mechanical transmission.

3. The electrospindle according to claim 2, wherein said first nut and second nut comprise mutual coupling means.

4. The electrospindle according to claim 1, wherein said mechanical transmission comprises a motor shaft having a first end operatively coupled to said motor and a second end constituting said free end of said mechanical transmission.

5. The electrospindle according to claim 1, wherein said transmission (3) comprises:
a motor shaft having a first end operatively coupled to said motor (2); and
an insert coupled at a first side by screwing to a second end of said motor shaft (15), a second side of said insert constituting said free end of said mechanical transmission (3).

6. The electrospindle according to claim 5, wherein said first side of said insert is threaded and said second end of said motor shaft comprises a first hole, which develops according to a longitudinal development axis of said motor shaft, said first hole being shaped on said first side of said insert and being threaded to receive said first side of said insert by screwing.

7. The electrospindle according to claim 5, wherein said second side of said insert comprises a second hole, which extends along a longitudinal development axis of said insert to receive and hold an additional tool.

8. The electrospindle according to claim 7, wherein said second hole is threaded to retain the additional tool by screwing.

9. The electrospindle according to claim 8, wherein a threading of said second hole is double by comprising a third right-handed thread and a fourth left-handed thread.
